(19) United States
(12) Patent Application Publication
(10) Pub. No.: US 2002/0178502 A1
(43) Pub. Date: Dec. 5, 2002

(54) Adjustable platform for a bed

(76) Inventors: Michael Beasley, Bedfordshire (GB); Stephen Hayes, West Midlands (GB); Stephen Hollyoak, West Midlands (GB)

Correspondence Address: Brown Raysman Millstein Felder & Steiner, 900 Third Avenue, New York, NY, 10022, US

(21) Appl. No.: 10/048,333

(22) PCT Filed: May 25, 2001
(86) PCT No.: PCT/GB01/02304

(30) Foreign Application Priority Data
May 27, 2000 (GB) 0012858.7
Jun. 27, 2000 (GB) 0015548.1

(51) Int. Cl. A61G 7/015

(52) U.S. Cl. 5/618

(57) ABSTRACT

A bed, couch or trolley platform arrangement consists of a back section (2), seat section (14), thigh section (15) and calf section (18). The backrest (14) and thigh section (15) are pivotally connected to the bed frame (4) for raising and lowering the hack section (14) and thigh section (15). The backrest and thigh section pivots are longitudinally displaceable along the frame away from each other as the back section and thigh section are raised from a horizontal to a raised potition. Bridging plates (13, 20) cover the gaps resulting from the displacement of the hack (14) and thigh (15) sections respectively. The back section also has an additional panel (6) which is arranged to slide upwards along the back section as the back section is raised causing the platform surface to lengthen by the same amount as the contact path length of skin of a person during sitting thereby resulting in prevention of pelvic compression and shearing of tissue.

This invention relates to bed, couch, trolley or similar platforms and, in particular, to a platform formed of a set of panels that pivot to provide configurations corresponding to various positions of a person's legs and torso.

Beds, trolleys or couches of various forms have been developed in order to provide comfort to the user. This is particularly true of persons who are bed ridden. When one is in bed for prolonged periods of time without the ability to move in order to maintain comfort, complications, such as pressure sores may develop. It is known to provide beds with platforms that can be moved into various orientations and configurations to accommodate the lack of movement of the patient. Each of these provide a back section that supports a person's torso and a seat section that supports the person's hips, a thigh section that supports the person's thighs and a calf section to support the legs.

On these beds, the proportion of a person's weight borne by the sacro/coxxygeal and buttock area increases markedly with the angle of the back section. This is due to a combination of the person's body sliding down the support surface together with a “pinching” action when the thigh and knee sections are also raised. This increases the distortion due to pressure and shear forces of soft tissues in this area, which in turn increases the risk of formation of pressure ulcers.

The degree of sliding and “pinching” is related to both the bed geometry and to the thickness of the support surface, for example, a mattress between the person and the bed surface. Generally speaking, the greater the thickness of support surface, the greater the degree of person sliding and poorer the “fit” of bed hinge points to locations of human joints. This issue is of increasing importance, since current good nursing practice involves more frequent use of thick, soft pressure reducing mattresses, which tend to cause longitudinal migration of the person as the backrest angle increases. In addition, as the length of lower limb in a person increases, so the degree of misfit increases.

A fundamental aspect of bending the human body into a semi-recumbent posture is that the contact path length of skin along the back is lengthened (typically by 150 mm) , particularly in the sacro/coxxygeal area, whereas the length of a support surface is inextensible, and often is reduced due to self-compression in the areas bounded by the articulating bed sections. This has the effect of driving the person's pelvis further into the mattress as the backrest angle increases, in an area already experiencing high localised contact pressures.

Thus, it is an object of the present invention to provide a platform that minimises the “pinching” action and has hinge points of the various bed sections coinciding closely with the joint positions of a person's body to be supported thereon.

Accordingly, the present invention provides a support platform for a bed, the platform supported on a frame and having a back section, a seat section, a thigh section and a calf section, at least both the back section and thigh section being pivotally connected to the frame, the pivoting axes of the back section and the thigh section are each arranged to be displaceable in the longitudinal direction so that as the back section and thigh section are pivoted from a horizontal position to a tilted position either individually or together, the respective back section and thigh section pivot axes are displaced, the seat section including a first panel pivotally attached to the seat section and cooperating with the back section, so that as the back section is longitudinally displaced from the seat section along the frame with increasing back section angle, the first panel bridges the resultant gap inbetween the seat and back sections. Preferably, a similar second panel may be attached to the other end of the seat section to bridge the gap inbetween the seat and thigh sections. Thus the first and second bridge panels ensure that a mattress supported upon the platform does not collapse into the gaps and diminish the improved pressure distribution. The above retracting back and thigh sections minimise “pinch” action to give a better distribution of interface pressure, a more comfortable resting posture, less abdominal compression, and better breathing (due to less pressure on the diaphragm). Preferably movement of the back section brings about a corresponding movement of the thigh section, to provide a comfortable “cradle” effect.

Preferably, the back section includes a third panel arranged to slide upwards along the back section as the back section is pivoted to the tilted position. The third panel movement allows the mattress surface to lengthen by the same amount as the contact path length of skin on the back of the person with increased back section angle, thereby minimising pelvic compression and shear in the sacro/coxxygeal area resulting in less tissue distortion and a further reduction of the “pinching” action.

Additionally preferably, the thigh section is extensible to accommodate different heights of people. The thigh section can be extended to more closely fit the platform sections to the person lying thereon. As a result the bed section hinge points are repositioned to coincide with the human joint locations of the person for a better distribution of pressure, particularly on the lower limb of the person supported thereon. Similarly, the calf section may be extensible to more closely tailor the bed sections to the different heights of people.

The invention will now be described by way of an example only with reference to the accompanying figures in which:—

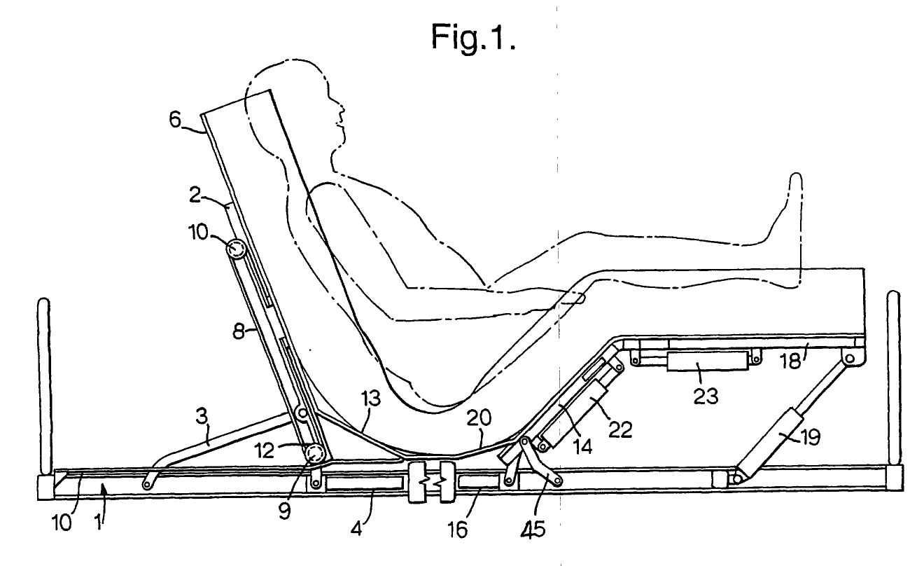

FIG. 1 is a schematic representation of one embodiment of a platform according to the invention;

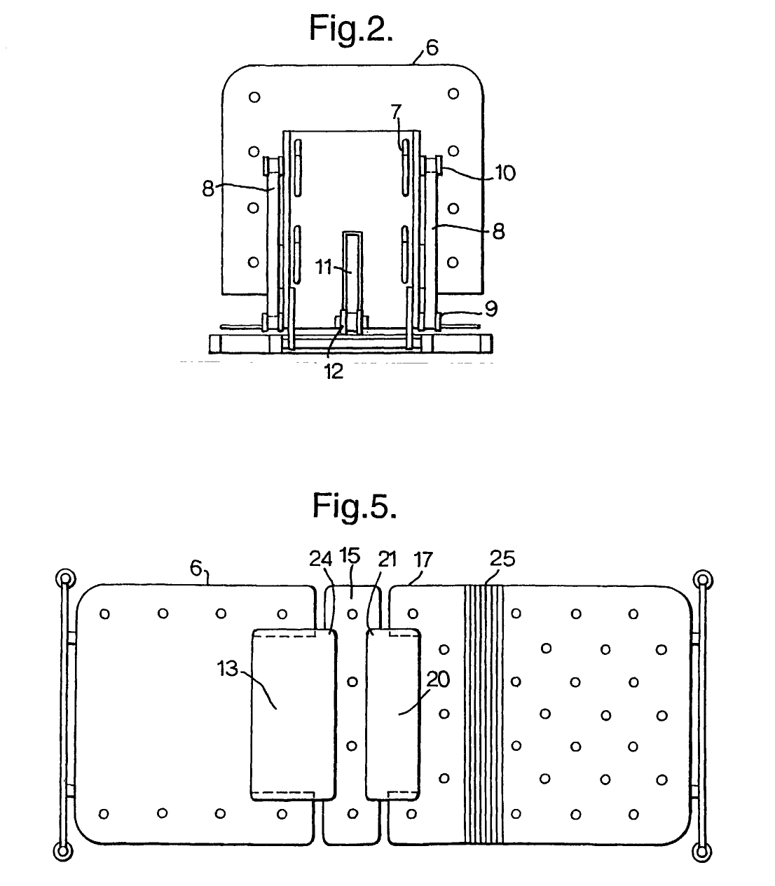

FIG. 2 is a front view of the back section in FIG. 1;

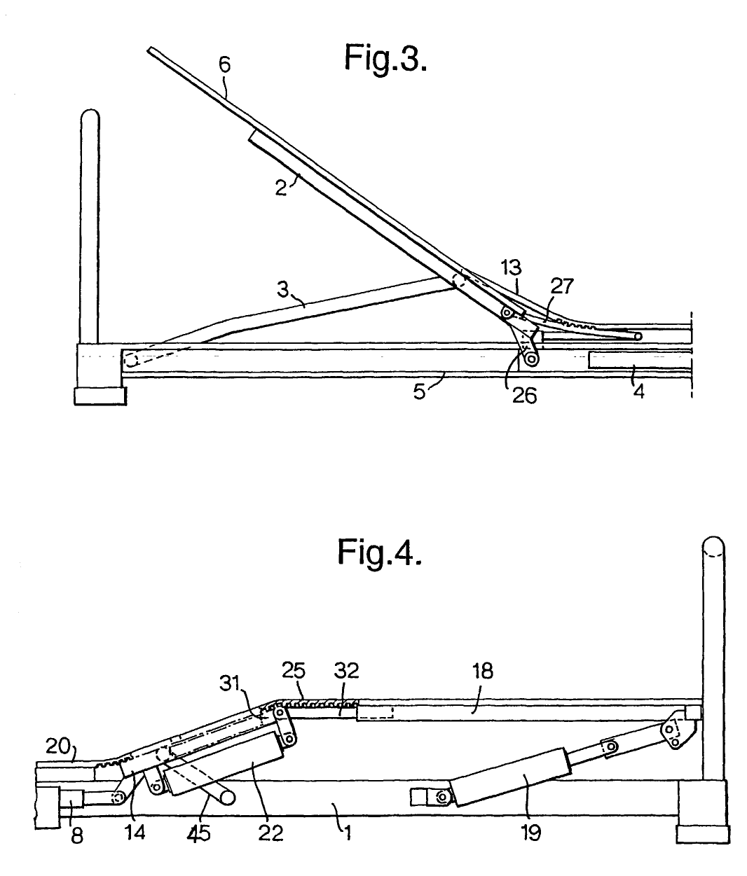

FIG. 3 is a schematic representation of another embodiment of a back section according to the invention;

FIG. 4 is a schematic representation of the thigh and calf sections according to the invention; and

FIG. 5 is a plan view of a platform according to the invention.

Referring to FIG. 1, the platform comprises several sections 2, 14, 15, 18 that can be profiled around the person's body to suit their requirements from a clinical and/or comfort point of view.

As shown in FIG. 2, one embodiment of the back section assembly consists of a panel 2 that is connected to the frame 1 via a link 3 and actuator 4. As the actuator 4 is extended, the lower end of the back section panel 2 slides along the frame 1 by virtue of slideblock 5 which slides in the channel form of the main frame members. The back section panel 2 rotates upward about it's pivot, under the influence of link 3 pivoted to the frame 1.

A shear panel 6 is mounted to the back section panel 2 via linear slides 7. As the back section slides outward along the frame, the shear panel 6 is pulled upward by the action of the belts 8. The belts 8 are fixed to the frame at their lower ends, and the shear panel 6 at their upper end. The belts 8 pass around free rotating pulleys 9 and 10 which are attached to the back section panel 2. Thereby as a result of the back section sliding outward along the frame, the back section shear panel 6 moves upward in relation to the back section panel 2.

As the actuator 4 is retracted the back section is pulled inward along the frame via the sliding block 5 and the back section rotates downward about its pivot under the action of link 3. As the back section rotates downward and slides inward, the belt 11 pulls the back section shear panel 6 downward in relation to the back section panel 2. This results from belt 11 being fixed to the frame at the head end, passing round pulley 12 which is attached to the back section panel 2, and then attached to the back section shear panel 6 at its midpoint.

The resultant gap which opens up between the back section shear panel 6 and the fixed seat section 15, as the back section is raised, is filled by bridge panel 13. The bridge panel 13 is hinged to the seat section 15 at points 22 and rests in a rebate in the back section the shear panel 6. As the back section shear panel 6 moves away from the seat section 15, the bridge panel 13 hinges about its lower end and slides along the rebate in shear panel 6. Therefore, as the back section assembly moves away from the fixed seat section 15, the bridge panel 13 remains in contact with both the seat section 15 and the back section shear panel 6 providing support to the mattress and person in this area.

As shown in FIG. 3, another embodiment of the back section replaces the belts 11 with sliding link 26 and push rod 27. The sliding link 26 is attached to the lower end of the backrest shear plate 6 and as the actuator 4 extends, this sliding link 26 is pulled along the axis of the bed. Attached to the other end of this sliding link 26 is a push rod 27, which is also connected to the lower end of the shear panel 6. As the actuator 4 extends, the push rod 7 causes the shear panel 6 to slide upward in relation to the backrest panel 2. The bridge panel 13 overlaps with the shear panel 6 and therefore, as the backrest is raised and retracted, this bridge panel 13 rises from it's normal flat position and bridges the gap that opens up between the backrest shear panel 6 and the seat section panel 2 of the bed platform.

The thigh section assembly consists of a panel 14 connected to the main frame 1 via a link 45 and actuator 16. As the actuator 16 is extended, the lower end of the thigh panel 14 slides along the frame by virtue of slideblock 5 and rotates upward about its pivot, under the influence of link 45 which freely pivots at its ends. Movement of the thigh section 14 may be simultaneous with any movement of the back section 2 to provide a “cradle” effect. The thigh section 14 may also be moved independently.

The calf section 18 is hinged at its one end to the thigh section 14 and supported at its other end by the actuator 19. As the thigh section 14 is raised, this causes the calf section 18 to be elevated. The angle of the calf section 18 to the horizontal is controlled by the extension/retraction of the actuator 19, which is free to pivot at its ends.

Fixed to the top surfaces of the thigh section 14 and calf section 18, is the thigh/calf support panel 17. This may be made in one piece with a series of flexible hinge joints across its width to allow bending about the hinge point between the thigh and calf sections.

The resultant gap that opens up between the thigh section 14 and the fixed seat section 15, as the thigh section 14 is raised, is filled by bridge panel 20. The bridge panel 20 is hinged to the seat section 15 at point 21 and rests in a rebate in the thigh/calf support panel 17. As the thigh section 14 moves away from the seat section 15, the bridge panel 20 pivots about its lower end and slides along the rebate in support panel 17. Therefore as the thigh section 14 assembly moves away from the fixed seat section 15, the bridge panel 20 remains in contact with both the seat section 15 and the thigh/calf support panel 17, providing support to the mattress and person in this area.

The thigh panel 14 and calf panel 18 may be joined by a flexible section 25.

The thigh panel 14 and the calf section panel 18 could both be telescopic in construction 31, 32 respectively. Actuators 22 and optionally 23 could be used to control the lengths of the thigh 14 and calf 18 sections respectively. By extending actuator 22 and retracting actuator 23 by the same amount, the point at which the thigh and calf sections hinge is moved further toward the foot end of the bed; effectively lengthening the thigh section 14 without increasing the overall length of the bed platform. The flexible section 25, between the thigh section 14 and calf section 18, allows the thigh/calf combination to hinge at any point between the minimum and maximum settings. In a similar manner as the actuator 22 is retracted and actuator 23 is extended by the same amount, the effective length of the thigh section 14 is decreased without affecting the overall length of the bed platform. Alternatively, only the thigh section length is varied by extending and retracting actuator 22.

The seat section 15 and the two bridge panels 13 and 20 could be one single moulding with flexible hinges. The actuator 19 could be replaced by a gas spring.

Although the present invention has been described with respect to a bed, it is clearly understood that the platform may be incorporated in a trolley, couch, table or similar multi-section planar support for a person to be supported thereon.

1. A support platform for a bed, the platform supported on a frame and having a back section, a seat section, a thigh section and a calf section, at least the back section pivotally connected to the frame, the pivoting axis of the back section arranged to be longitudinally displaceable along the frame so that as the back section is pivoted from a horizontal to a tilted position the pivot axis is displaced longitudinally along the frame, the seat section including a first panel pivotally attached thereto and cooperating with the back section, such that as the back section is displaced longitudinally from the seat section along the frame with increasing back section angle, the first panel bridges the resultant gap inbetween the seat and back sections.

2. A support platform as claimed in claim 1, wherein the thigh section is also pivotally connected to the frame, the pivoting axis of the thigh section arranged to be longitudinally displaced away from the back section as the thigh section is pivoted from a horizontal position to a tilted position, the seat section including a second panel pivotally attached to the end of the seat section adjacent the thigh section and cooperating with the thigh section such that as the thigh section is displaced longitudinally from the seat section along the frame with increasing thigh section angle, the second panel bridges the gap inbetween the seat and thigh sections.

3. A support platform as claimed in claim 2, wherein movement of the back section brings about a corresponding movement of the thigh section.

4. A support platform as claimed in claims 1, 2 or 3, wherein the back section includes a third panel arranged to slide upwards along the back section as the back section is pivoted to the tilted position.

5. A support platform as claimed in any preceding claim, wherein the seat section and first and second panels comprise a single moulding.

6. A support platform as claimed in any preceding claim, wherein the thigh section is extensible to accommodate for different heights of people.

7. A support platform as claimed in any preceding claim, wherein the calf section is extensible to accommodate for different heights of people.

8. A support platform as claimed in claim 6 or 7, wherein the thigh and calf sections are joined by a flexible panel.
